(19) United States
(12) Patent Application Publication
(10) Pub. No.: US 2022/0005114 A1
(43) Pub. Date: Jan. 6, 2022

(54) SYSTEMS AND METHODS FOR RE-CREATING AN EXPERIENCE OF A USER

(71) Applicant: Wells Fargo Bank, N.A., San Francisco, CA (US)

(72) Inventors: Tambra Nichols, Charlotte, NC (US); Daniel Sanford, Charlotte, NC (US); Tosha Wesley, Charlotte, NC (US); Ximing Zhao, Charlotte, NC (US)

(21) Appl. No.: 15/435,706

(22) Filed: Feb. 17, 2017

Related U.S. Application Data
(60) Provisional application No. 62/440,388, filed on Dec. 29, 2016.

(51) Int. Cl. G06Q 40/02; G06Q 10/02; G06F 17/30

(52) U.S. Cl. CPC G06Q 40/02; G06F 17/30424; G06Q 10/02

(57) ABSTRACT

Systems and methods for re-creating an experience of a user are provided. A plurality of financial transactions can be received. A plurality of parameters associated with each financial transaction of the plurality of financial transactions can be determined. A query can be received from a remote computing device. The query can include information identifying the experience. The information identifying the experience can be compared with the plurality of parameters associated with each financial transaction of the plurality of financial transactions. At least one financial transaction of the plurality of financial transactions can be identified as corresponding to the experience, based on a result of the comparison of the information identifying the experience with the plurality of parameters associated with each financial transaction of the plurality of financial transactions.

### CROSS-REFERENCE TO RELATED APPLICATIONS

This application claims priority to U.S. Provisional Patent Application No. 62/440,388 entitled “SYSTEMS AND METHODS FOR RE-CREATING AN EXPERIENCE OF A USER”, filed Dec. 29, 2016, incorporated herein by reference in its entirety.

### TECHNICAL FIELD

Embodiments of the present disclosure generally relate to recalling and/or re-creating an experience of a user.

### BACKGROUND

Individuals conduct financial transactions frequently. Some such transactions are associated with overall positive experiences. For example, a first user may have had a positive experience at a restaurant or at a particular service provider. In some instances, the first user or a second individual may wish to recall or repeat an event experienced by a first user, for example based on a recommendation provided by the first user. However, the first user may not remember the details of financial transactions associated with the positive past experience, thereby making it difficult for the individual (or a second individual) to re-create the experience at a later time.

### SUMMARY

One example embodiment relates to a computer-implemented method for re-creating an experience of a user. The method includes receiving, by an account management circuit, a plurality of financial transactions. The method includes determining, by a parameter determination circuit, a plurality of parameters associated with each financial transaction of the plurality of financial transactions. The method includes receiving, by an experience identification circuit, a query from a remote computing device. The query includes information identifying the experience. The method includes comparing, by the experience identification circuit, the information identifying the experience with the plurality of parameters associated with each financial transaction of the plurality of financial transactions. The method includes identifying, by the experience identification circuit, at least one financial transaction of the plurality of financial transactions as corresponding to the experience, based on a result of the comparison of the information identifying the experience with the plurality of parameters associated with each financial transaction of the plurality of financial transactions.

Another example embodiment relates to a system for re-creating an experience of a user. The system includes an account management circuit configured to receive a plurality of financial transactions. The system includes a parameter determination circuit configured to determine a plurality of parameters associated with each financial transaction of the plurality of financial transactions. The system includes an experience identification circuit configured to receive a query from a remote computing device. The query includes information identifying the experience. The experience identification circuit is further configured to compare the information identifying the experience with the plurality of parameters associated with each financial transaction of the plurality of financial transactions. The experience identification circuit is further configured to identify at least one financial transaction of the plurality of financial transactions as corresponding to the experience, based on a result of the comparison of the information identifying the experience with the plurality of parameters associated with each financial transaction of the plurality of financial transactions.

These and other aspects and arrangements are discussed in detail below. The foregoing information and the following detailed description include illustrative examples of various aspects and arrangements, and provide an overview or framework for understanding the nature and character of the claimed aspects and arrangements. The drawings provide illustration and a further understanding of the various aspects and arrangements, and are incorporated in and constitute a part of this specification.

### BRIEF DESCRIPTION OF THE DRAWINGS

FIG. 1 is a block diagram of a computing environment for re-creating an experience of a user, according to an example embodiment;

FIG. 2 is a detailed schematic diagram of the computing environment of FIG. 1, according to an example embodiment;

FIG. 3 is detailed schematic diagram of an experience re-creation system included in the environment of FIG. 2, according to an example embodiment;

FIGS. 4A and 4B are graphical user interfaces, according to example embodiments; and

FIG. 5 is a flowchart illustrating an example method for re-creating an experience of a user, according to an example embodiment.

### DETAILED DESCRIPTION

The present disclosure is generally directed to systems and methods for recalling and/or re-creating an experience of a user. Users conduct financial transactions in connection with various experiences. Some such experiences may be particularly memorable, such as a vacation, a date, a birthday, an anniversary, a holiday, or a honeymoon. Users may therefore want to recall or recreate aspects of such experiences at a later time. For example, a user may remember enjoying a meal at a restaurant while on vacation, but may be unable to remember the name of the restaurant. As a result, the user may be unable to revisit the restaurant later. The user also may be unable to recommend the restaurant to a friend or family member.

According to various example embodiments, as described further below, a system is configured to help a user recall or re-create at least a portion of a past experience. Using the system, the user does not have to remember all of the details about the past experience in order to recall or re-create the past experience. Instead, the user can provide various forms of contextual information about the experience. The contextual information can include a time, a location, an event, or a date associated with the experience. The system uses the contextual information to identify one or more transactions associated with the experience, and a list of the identified transactions can be provided to the user. In some arrangements, a user provides contextual information relating to an experience had by another user (e.g., a friend or a family member), and the system returns a list of transactions associated with the other user's experience. In some arrangements, the system is further configured to initiate an action that can help the user to re-create the experience. For example, the system can be configured to make a reservation at a restaurant associated with the past experience. In another example, the system can make travel arrangements for the user to a destination associated with the past experience.

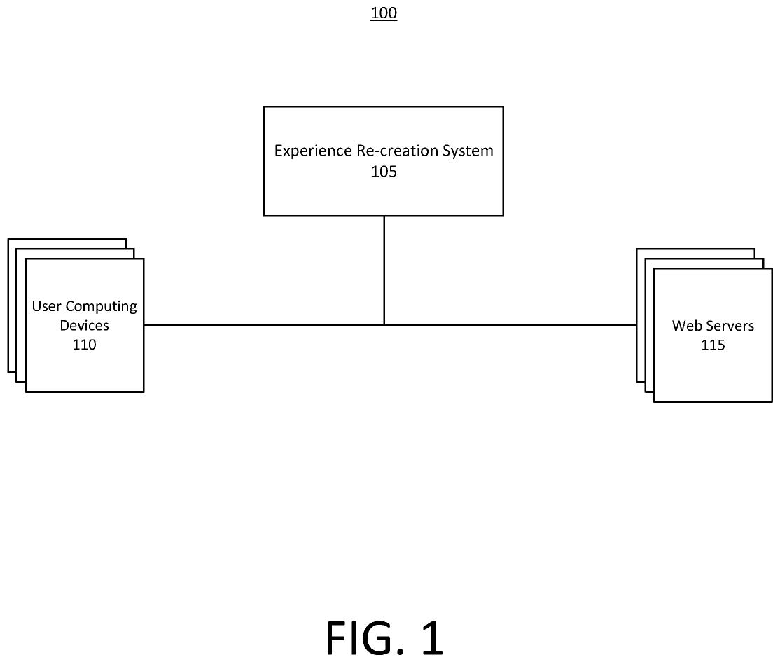

FIG. 1 is a block diagram of a computing environment 100 for re-creating an experience of a user, according to an example embodiment. The environment 100 includes an experience re-creation system 105, a plurality of user computing devices 110, and a plurality of web servers 115. The user computing devices 110 and the web servers 115 are communicatively coupled to one another, and to the experience re-creation system 105. The computing environment 100 of FIG. 1 is used to re-create a past experience of a user, such as a user of one of the user computing devices 110. In some arrangements, a user may user a user computing device 110 to provide contextual information relating to a past experience to the experience re-creation system 105. The experience re-creation system 105 identifies the past experience based on the contextual information, and determines one or more transactions associated with the identified experience. In some arrangements, the experience re-creation system performs an action Intended to facilitate re-creation of at least a portion of the experience for the user.

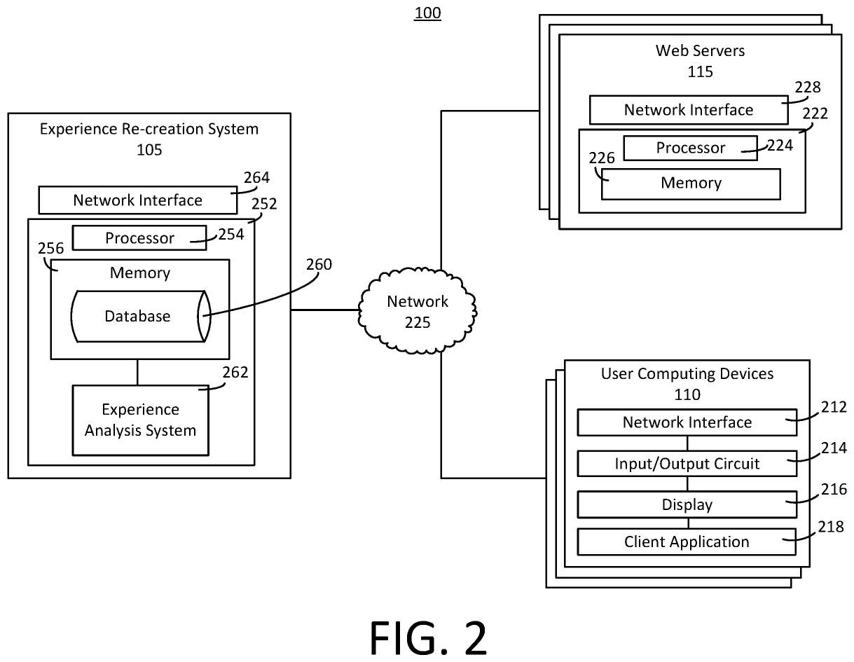

Referring now to FIG. 2, a detailed schematic diagram of the computing environment 100 of FIG. 1 is shown. The components of the environment 100, such as the experience re-creation system 105, the user computing devices 110, and the web servers 115, are communicatively coupled to one another via a network 225. In some arrangements, the network 225 includes any of the Internet, a private network, a wide area network (WAN), or a combination thereof. It should be understood that, although only a single network 225 is shown in FIG. 2 for illustrative purposes, in some arrangements the components of the environment 100 are interconnected to one another via two or more interconnected computer networks that may be combined to implement the network 225.

The experience re-creation system 105 is configured to assist a user in recalling or re-creating a past experience. The user may be a user of one of the computing devices 110. The experience re-creation system 105 can receive information relating to a plurality of financial transactions involving the users of the user computing devices 110. In some arrangements, the experience re-creation system 105 is owned or operated by a financial institution that processes financial transactions conducted by the users, and may store information relating to the transactions to allow the transactions to later be identified as corresponding to past experiences. For each transaction, the experience re-creation system 105 determines a plurality of parameters associated with the transaction. Parameters may include information such as a time or location at which the transaction occurred, an event associated with the transaction, and one or more user ratings associated with the transaction. In some implementations, the experience re-creation system receives additional contextual information from the web servers 115. For example, the web servers 115 host websites related to business reviews or social media. Thus, the experience re-creation system 105 can retrieve from the web servers 115 information related to a customer review of a product or service associated with a transaction, or an emotional response experienced by a user when the transaction was conducted.

In some arrangements, the user computing devices 110 are computing devices associated with individual users or small groups of users (e.g., a family, a group of friends, or a business), where each user is an individual. Each of the user computing devices 110 may be any type or form of computing device owned by, operated by, accessed by, or otherwise associated with a respective user. In some arrangements, each of the user computing devices 110 is at least one of a server, a desktop computer, or a laptop computer. In some other arrangements, each of the user computing devices 110 is a mobile computing device such as a tablet computing device, or a handheld computing device, such as a smartphone.

Each user computing device 110 includes a network interface 212, an input/output circuit 214, a display 216, and a client application 218. The network interface 212 of the user computing device 110 is adapted for and configured to establish a communication session via the network 225 with the experience re-creation system 105 or the web servers 115. Accordingly, the network interface 212 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver).

The display 216 is used to present account information, experience information, transaction information, and the like. In this regard, the display 216 is communicably and operatively coupled to the input/output circuit 214 to provide a user interface for receiving and displaying information on the user computing device 110. The input/output circuit 214 is structured to receive and provide communication(s) to a user of the user computing device 110. In this regard, the input/output circuit 214 is structured to exchange data, communications, instructions, etc., with an input/output component of the user computing device 110. Accordingly, in one embodiment, the input/output circuit 214 includes an input/output device such as a display device, a touchscreen, a keyboard, and a microphone. In another embodiment, the input/output circuit 214 may include communication circuitry for facilitating the exchange of data, values, messages, and the like between an input/output device and the components of the user computing device 110. In yet another embodiment, the input/output circuit 214 may include machine-readable media for facilitating the exchange of information between the input/output device and the components of the user computing device 110. In still another embodiment, the input/output circuit 214 may include any combination of hardware components (e.g., a touchscreen), communication circuitry, and machine-readable media.

The client application 218 is communicably coupled to the experience re-creation system 105 and the web servers 115 via the network 125, and may be structured to permit completion of financial transactions via the client application 218. In this regard, the client application 218 may provide displays indicative of current account balances, pending transactions, profile information (e.g., contact information), location information, device data, and the like. Further, in some arrangements, the client application 218 may also permit payments to and/or from the user to a designated recipient (e.g., a merchant). In some arrangements, the client application 218 is configured to display information that facilitates re-creation of an experience for the user of the user computing device 110. For example, in some arrangements the client application 218 is configured to prompt the user to enter contextual information about an experience that the user would like to recall or re-create. The client application 218 is further configured to provide results to the user corresponding to financial transactions associated with the experience that the user would like to recall or re-create. Accordingly, the client application 218 can be configured to display one or more graphical user interfaces (GUIs) to provide such information to the user. In some other arrangements, the client application 218 is configured to display a suggestion or recommendation of one or more experiences that the user may wish to re-create without receiving any prior contextual information. For example, information corresponding to the suggested or recommended experience can be received by the client application 218 from the experience re-creation system 105, as described further below.

The web servers 115 correspond to a computing device owned by, operated by, accessed by, or otherwise associated with third parties. In some arrangements, a web server 115 hosts a social media website, such as Facebook® or Twitter®. Such a web server stores information corresponding to posts (e.g., graphical, video, and text-based information) provided by users of the user computing devices 110. Such posts also may include other information corresponding to a time and/or a location at which each post was created, for example in the form of metadata associated with the respective posts. In some other arrangements, a web server 115 hosts a website providing access to customer reviews for various products and services, such as Yelp® or TripAdvisor®. Such a ratings website can be accessed by users of the user computing devices 110 to allow the users to submit reviews based on the products and services they purchase from various merchants. Like the user computing devices 110, each web server 115 also can be implemented as any type and form of computing device, including a server, a desktop computer, a laptop computer, a tablet computing device, or a smartphone. In some arrangements, websites hosted by the web servers 115 can be registered with the experience re-creation system 105. For example, owners of the web servers 115, or users of the websites hosted by the web servers 115 (e.g., users associated with the user computing devices 110) may explicitly provide permission to the experience re-creation system 105 to access information hosted by the web servers 115.

Each web server 115 includes a processing circuit 222 having a processor 224 and a memory 226. The processor 224 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices 226 (e.g., RAM, NVRAM, ROM, Flash Memory, hard disk storage, etc.) may store data and/or computer code for facilitating the various processes described herein. Moreover, the one or more memory devices 226 may be or include tangible, non-transient volatile memory or non-volatile memory. Accordingly, the one or more memory devices 226 may include database components, object code components, script components, or any other type of information structure for supporting the various activities and information structures described herein.

Each web server 115 further includes a network interface 228. The network interface 228 is adapted for and configured to establish a communication session via the network 225 with the experience re-creation system 105 and the user computing devices 110. Accordingly, the network interface 228 includes any of a cellular transceiver (CDMA, GSM, LTE, etc.), a wireless network transceiver (e.g., 802.11X, ZigBee, Bluetooth, etc.), or a combination thereof (e.g., both a cellular transceiver and a Bluetooth transceiver).

The experience re-creation system 105 is configured to help users of the user computing devices 110 to recall or re-create past experiences, based on financial transaction data and other contextual information. As shown, the experience re-creation system 105 includes a processing circuit 252 having a processor 254 and a memory 256. The processor 254 may be implemented as a general-purpose processor, an ASIC, one or more FPGAs, a DSP, a group of processing components, or other suitable electronic processing components. The one or more memory devices 256 (e.g., RAM, NVRAM, ROM, Flash Memory, hard disk storage, etc.) may store data and/or computer code for facilitating the various processes described herein. Moreover, the one or more memory devices 256 may be or include tangible, non-transient volatile memory or non-volatile memory. Accordingly, the one or more memory devices 256 may include database components such as the database 260, object code components, script components, or any other type of information structure for supporting the various activities and information structures described herein.

The experience re-creation system 105 further includes a network interface 264, which is used to establish connections with other components of the environment 100 by way of the network 225. The network interface 264 includes program logic that facilitates connection of the experience re-creation system 105 to the network 225. The network interface 264 supports communication between the experience re-creation system 105 and other systems, such as the user computing devices 110 and the web servers 115. For example, in some arrangements the network interface 264 includes at least one of a cellular modem, a Bluetooth transceiver, a radio-frequency identification (RFID) transceiver, and an NFC transmitter. In some arrangements, the network interface 264 includes the hardware and machine-readable media sufficient to support communication over multiple channels of data communication. Further, in some arrangements, the network interface 264 includes cryptography capabilities to establish a secure or relatively secure communication session with user computing devices 110 and the web servers 115. In this regard, financial data (or other types of data) may be encrypted and transmitted to prevent or substantially prevent the threat of hacking.

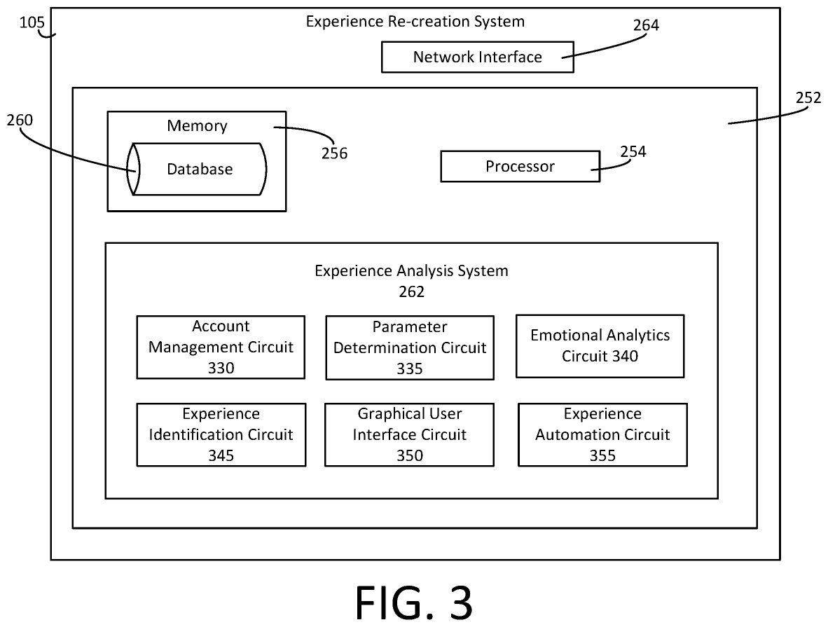

The experience re-creation system 105 further includes a database 260. The database 260 is configured to hold, store, categorize, and otherwise serve as a repository for information related to financial transactions conducted by users of the user computing devices 110 and experiences associated with those transactions. For example, the database 260 may store financial transaction data (e.g., an account associated with a transaction, a dollar amount of the transaction, and identities of the counterparties to the transaction) as well as contextual information relating to the transaction data (e.g., an event associated with the transaction or an emotional response experienced by the user as a result of the transaction). The database 260 is structured to selectively provide access to information relating to financial transactions associated with various user experiences. In this regard, as discussed further herein, the database 260 is communicably and operatively coupled to an experience analysis system 262 to provide access to such information. Although shown as being part of the memory 256 in FIG. 2, the database 260 may be separate from the memory 256 and may be a stand-alone component of the experience re-creation system 105. The experience analysis system 262 is configured to assist a user in submitting a query related to an experience the user would like to recall or re-create, to identify the experience based on the query, and to provide an identification of one or more financial transactions associated with the experience. In some arrangements, the experience analysis system 262 can determine one or more suggested or recommended experiences that the user may wish to re-create, even if the user has not submitted a query. The user may then provide an indication of whether the user wishes to re-create the suggested or recommended experience. In some arrangements, the experience analysis system 262 is further configured to initiate an action to allow the user to re-create the identified experience. The experience analysis system 262 is described further below in connection with FIG. 3.

The experience re-creation system 105 may be maintained by an organization, such as a financial institution, that also has access to financial accounts associated with at least some of the users of the user computing devices 110 and/or the financial transactions involving those financial accounts. In some arrangements, the financial institution processes payment transactions (e.g., credit card transaction, debit card transactions, mobile wallet transactions, gift card transactions, and the like). For example, the experience re-creation system 105 may be maintained by a bank that maintains the accounts of users of the user computing devices 110 and/or processes transactions made by users of the user computing devices 110. In one example, a user computing device 110 includes an NFC-enabled smartphone capable of completing a financial transaction at a point-of-sale device. Thus, a user can make a purchase from a merchant using the smartphone. Communications from the user computing device 110 that result from the transaction may traverse the network 225. In some arrangements, at least some such communications also are received by the experience re-creation system 105 (e.g., via the network interface 264). In some other arrangements, the experience re-creation system 105 may receive an indication that a financial transaction has been conducted by a user, for example if the user paid for the purchase with funds stored in an account to which the experience re-creation system 105 has access. The experience re-creation system 105 uses such financial transaction information, along with other contextual information, to help a user recall or re-create a past experience, as discussed further below.

Referring now to FIG. 3, a detailed schematic diagram of the experience analysis system 262 and part of the experience re-creation system 105 included in the environment 100 of FIG. 2 is shown, according to an example embodiment. The experience analysis system 262 is shown to include an account management circuit 330, a parameter determination circuit 335, an emotional analytics circuit 340, an experience identification circuit 345, a graphical user interface (GUI) circuit 350, and an experience automation circuit 355. It should be understood that other arrangements of the experience analysis system 262 may include more or fewer circuits without departing from the spirit and scope of this disclosure. Furthermore, in some arrangements, the functionality of one or more circuits may be combined into a single circuit and/or into circuits separate from the processing circuit 252. Within the experience re-creation system 105, the experience analysis system 262 is operably and communicatively coupled to the database 260 and the processor 254. FIG. 3 is described with reference to FIGS. 1 and 2 below.

The account management circuit 330 is configured to receive information corresponding to a plurality of financial transactions involving the users of the user computing devices 110. In some arrangements, the information corresponding to such financial transactions is stored in the database 260. In some arrangements, the information includes a time at which the transaction was completed, a location at which the transaction was completed, an identity of one or more counterparties to the transaction, a dollar amount associated with the transaction, and a product or service associated with the transaction. The account management circuit 330 is configured to retrieve the information from the database 260. In some arrangements, the database 260 stores a table having entries corresponding to various financial transactions. The account management circuit 330 is configured to query the database 260 for all of the financial transactions specified criteria (e.g., were initiated by a particular user on a particular date), and to receive the results returned by the database 260 in response to the query.

In some arrangements, the account management circuit 330 is further configured to process transactions rather than merely to receive information relating to previously processed transactions. For example, a user of a user computing device 110 may be the holder of a credit card account whose information is stored in the database 260. When the user attempts to conduct a financial transaction (e.g., purchase a product or service), the account management circuit 330 receives a notification of the requested transaction via the network 225. The account management circuit 330 retrieves corresponding account information from the database 260. In some arrangements, the account management circuit 330 determines whether the account has sufficient credit or funds available to complete the requested transaction and, if so, authorizes the financial transaction. In some arrangements, the account management circuit 330 also stores a record of the financial transaction in the database 260 for later retrieval.

The parameter determination circuit 335 is configured to determine one or more parameters associated with each financial transaction received or processed by the account management circuit 330. Parameters for a transaction can include a time at which the transaction was conducted, a merchant associated with the transaction, and a customer associated with the transaction (e.g., an identification of a user of a user computing device 110 used to conduct the transaction). In some arrangements, the parameter determination circuit 335 determines one or more events associated with a transaction. The determination of an event can be based in part on other parameters determined by the parameter determination circuit 335. For example, the parameter determination circuit 335 can determine that a transaction occurred at a merchant corresponding to a restaurant, and may therefore determine that an event associated with the transaction is a meal. Continuing this example, the parameter determination circuit 335 can further determine that the transaction took place in the evening (e.g., based on a time stamp associated with the transaction), and therefore that the event associated with the transaction is a dinner. In some arrangements, the parameter determination circuit 335 determines that an event parameter of a transaction is a vacation or other trip based on a determination that the transaction was conducted at location far from the home of the user who initiated the transaction. In some arrangements, the parameter determination circuit 335 accesses a calendar of the user which may be stored, for example, on the user computing device 110 of the user to determine events or appointments scheduled at or near the time that the transaction took place. The parameter determination circuit can then determine that the appointment or event on the user's calendar is associated with the transaction.

In some arrangements, the parameter determination circuit 335 determines a rating parameter associated with a transaction. The rating parameter may correspond to a level of satisfaction or dissatisfaction experienced by the user who conducted the transaction. In one example, the parameter determination circuit 335 makes such a determination by receiving rating information directly from the user computing device 110 of the user who initiates the transaction. In another example, the parameter determination circuit 335 determines rating information for a transaction by querying a ratings website hosted by one or more of the web servers 115. The parameter determination circuit 335 can determine an identity of the user who initiated the transaction, and can then search for reviews or ratings submitted to the ratings website hosted on the one or more web servers 115 by the identified user. For example, in some arrangements the ratings website can be registered with the experience re-creation system 105, thereby allowing the experience re-creation to access information hosted on the ratings website. In some arrangements, the parameter determination circuit 335 parses such reviews for terms such as the name of a merchant associated with the transaction to ensure that the review corresponds to the transaction. The rating information (e.g., a numerical rating from one through five, with higher numbers indicating a higher level of satisfaction) can be determined as the rating parameter for the transaction. In some arrangements, the parameter determination circuit 335 receives an emotional response parameter associated with a transaction from the emotional analytics circuit 340, as described further below. The parameter determination circuit 335 stores the parameters associated with each transaction in the database 260.

The emotional analytics circuit 340 is configured to determine an emotional response of the user who initiated a particular financial transaction. The emotional response of the user corresponds to any emotion experienced by the user as a result of the transaction (e.g., happiness, excitement, anger, disappointment, sadness, contentedness, etc.) and is determined based on information received from the user at the time of the financial transaction. In one example, the emotional analytics circuit 340 begins by determining, receiving, or otherwise identifying a financial transaction for which emotional response information is desired. The emotional analytics circuit 340 then determines a time at which the transaction was conducted, for example by retrieving a time parameter from the parameter determination circuit 335 or from the database 260. Next, the emotional analytics circuit 340 receives information associated with an emotional response of the user during the time at which the transaction was conducted, and analyzes the information to determine the user's emotional response to the transaction. In some arrangements, the information associated with the user's emotional response is provided directly by the user. For example, the user may manually enter emotional response information (i.e., an indication of whether the user enjoyed an experience associated with a transaction) on the user computing device 110, and the information can be transmitted tot eh experience re-creation system 105 where it is processed by the emotional analytics circuit 340. In some implementations, the user can be prompted to enter such information for a transaction shortly after conducting the transaction.

In some arrangements, the user can allow the experience re-creation system 105 to access other information in order to allow the experience re-creation system 105 to determine the user's emotional response automatically. For example, In some arrangements, the information associated with the user's emotional response is audio information corresponding to the user's voice. Such information is collected, received, or otherwise accessed by the experience re-creation system on an opt-in basis after the user has provided permission for such information to be accessed. The audio information can be a telephone conversation conducted by the user, or an in-person conversation between the user and another person. For example, the emotional analytics circuit 340 can receive such information via the user computing device 110 used by the user. As described above, the user computing device 110 includes an input/output circuit 214 that can be or can include a microphone or other audio input device that receives voice information from the user. The voice information can be transmitted to the experience re-creation system 105 via the network 225, and can be received by the emotional analytics circuit 340. In some arrangements, the emotional analytics circuit 340 implements voice recognition functionality to determine the content of a conversation or phone call held by the user. The content of the conversation or phone call can be processed to determine the user's emotional response. For example, the emotional analytics circuit 340 can determine that the user is satisfied with the transaction by determining that the user uses positive words (e.g., words indicating happiness or satisfaction) during the conversation or phone call. In contrast, the emotional analytics circuit 340 determines that the user is disappointed when the conversation or phone call includes a large number of negative words. In some arrangements, information other than the content of the conversation or phone call can be used to determine the user's emotional response. For example, the emotional analytics circuit 340 may use volume information to determine whether the user is excited (e.g., due to a louder volume of the conversation or phone call).

In some arrangements, the information associated with the user's emotional response is text-based information. Like the audio information described above, text-based information also can be collected from the user on an opt-in basis after the user has permitted access to such information. The text-based information can correspond to one or more text messages or emails sent by a user computing device 110. In some arrangements, the emotional analytics circuit 340 communicates with the user computing device 110 to retrieve text messages or emails stored on the user computing device 110. The emotional analytics circuit 340 analyzes the text messages and emails to identify text messages and emails that were sent or received by the user computing device 110 around the time that the financial transaction was conducted. In some arrangements, the emotional analytics circuit 340 processes the identified text messages and emails to determine an emotional state of the user. The emotional analytics circuit 340 can analyze the content of the text messages and emails to determine words, punctuation, etc. indicative of an emotional state of the user. For example, certain words or phrases may be correlated with various emotional states, and the emotional analytics circuit 340 is configured to determine the emotional state of the user based on the relative frequency with which such words or phrases appear in the identified text messages and emails. In some arrangements, text-based information is received in other forms. For example, text-based information can be extracted from social media posts created by a user of the user computing device 110. The emotional analytics circuit 340 can receive information corresponding to social media posts from a social media website, which may be hosted, for example, by a web server 115. The textual information included in a social media post can be analyzed by the emotional analytics circuit 340 as described above. In some arrangements, the social media website can be linked or otherwise associated with the experience re-creation system 105. For example, in some arrangements the user may explicitly authorize the experience re-creation system 105 to access information in social media posts that the user creates.

The experience identification circuit 345 is configured to help a user to recall or re-create a past experience. To that end, in some arrangements the experience identification circuit 345 receives a query from a user computing device 110 that includes information relating to an experience. The information included in the query may include any type or form of information associated with a past experience. The user may not remember all of the details of a past experience, and therefore may not be able to provide such details. Accordingly, in some arrangements, the user provides contextual information relating to the experience, such as a time and/or location at which the experience took place, an event associated with the experience, an emotional response associated with the experience, etc. The experience identification circuit 345 receives this information from the user computing device 110.

When the experience identification circuit 345 receives a query from the user computing device 110, the experience identification circuit 345 is configured to compare the information received from the user computing device 110 with the parameters associated with the plurality of transactions as determined by the parameter determination circuit 335. In some arrangements, the experience identification circuit 345 parses the query received from the user computing device 110 to determine one or more search terms (e.g., words or phrases) that can be compared with the parameters of the plurality of transactions. The experience identification circuit 345 then determines a match or a similarity between the identified search terms from the query and the parameters of at least one financial transaction. Based on the match or similarity, the experience identification circuit 345 determines that the at least one financial transaction corresponds to the experience that the user wishes to recall or recreate. In some arrangements, the experience identification circuit 345 responds to the query by providing a list of the one or more identified transactions to the user computing device 110.

In some arrangements, the experience identification circuit 345 is configured to identify an experience that a user may wish to re-create without receiving a query from the user computing device 110. The experience can be identified as an experience that a user may wish to re-create, and can be provided to the user as a suggestion or recommendation. The experience identification circuit 345 can identify a suggested or recommended experience based on the parameters or events associated with a user's past transactions. For example, the experience identification circuit 345 may determine that a past transaction conducted by a user corresponds to an event in celebration of the user's birthday. A year later, the experience identification circuit 345 identifies the birthday celebration as an experience that the user would likely be interested in re-creating at that time, and provides the identified experience as a suggestion or recommendation to the user computing device 110. In another example, the experience identification circuit 345 determines that a past transaction corresponds to a restaurant meal purchased by a user during a trip to a new city. At a later time, the experience identification circuit 345 determines that the user has returned to the city in which the restaurant meal was purchased, for example by receiving location data from the user computing device 110. As a result, the experience identification circuit 345 identifies the restaurant meal as an experience that the user may wish to re-create. In this way, the experience identification circuit 345 can identify experiences that a user may wish to re-create even if the user has forgotten about the experience at a later time. In some arrangements, after the identified experience has been suggested or recommended to the user, the experience identification circuit 345 can receive an indication that the user has confirmed a desire for the experience to be created. For example, the confirmation indication can be received from the user computing device 110.

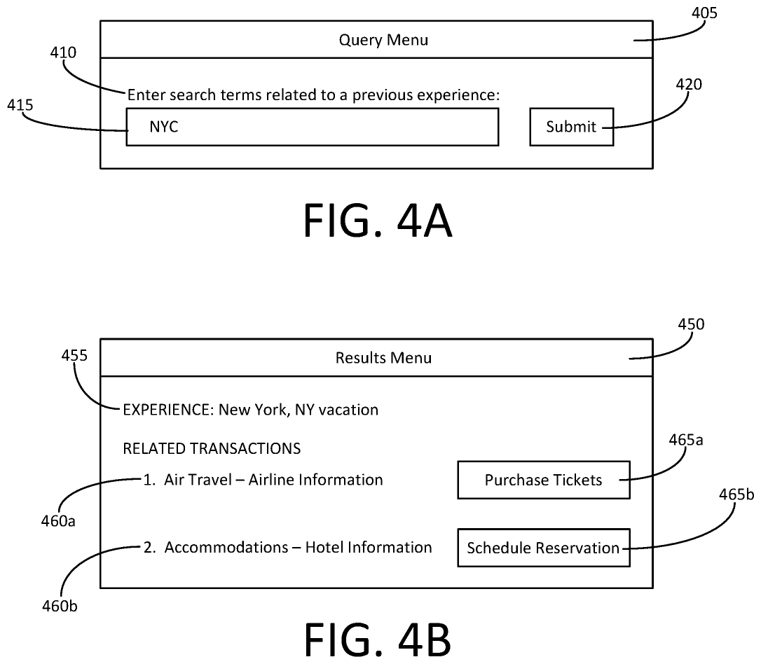

The graphical user interface (GUI) circuit 350 is configured to generate various GUIs to be displayed to a user. For example, FIGS. 4A and 4B show two user interfaces that can be generated by the GUI circuit 350. FIGS. 4A and 4B are described in connection with FIG. 3 below. A query menu GUI 405 is shown in FIG. 4A. The query menu 405 allows a user to submit a query relating to an experience that the user wishes to recreate. The query menu 405 includes a text prompt 410 that instructs the user to enter search terms related to a previous experience. A text field 415 allows the user to enter the desired search terms, and a submit button 420 can be selected by the user to submit the query. In this example, the user has entered “NYC” in the text field 415.

In some arrangements, the GUI circuit 350 generates information corresponding to the query menu 405, and transmits the information to a user computing device 110 via the network 225 to cause the user computing device 110 to display the information. For example, the query menu 405 can be displayed on the display 216 of the user computing device 110. In some arrangements, the query menu 405 is displayed in connection with execution of the client application 218. The user can enter text into the text field 415 via the input/output circuit 214 of the user computing device 110, which may include a keyboard interface to allow the user to enter text. Selection of the submit button 420 can cause the user computing device 110 to transmit the information in the text field 415 to the experience re-creation system 105 via the network 225. The components of the experience analysis system 262 can then process the received query as described above to identify one or more financial transactions associated with the experience that the user wishes to recall or re-create.

FIG. 4B shows a results menu 450. The results menu 450 provides a visual representation of financial transactions corresponding to an experience that the user wishes to recall or re-create, based on the search terms entered by the user in the query menu 405. The results menu 450 includes an identification of the experience 455 (in this instance, a vacation to New York), as well as a list of related financial transactions 460a and 460b. As shown, financial transaction 460a relates to air travel and includes detailed information relating to the air travel financial transaction conducted as part of the experience 455. For example, the detailed information can include the name of the airline, the departure and destination airports, the cost of the tickets, the number of tickets purchased, and the date of the flight. The financial transaction 460a relates to hotel accommodations and includes detailed hotel information. The detailed hotel information can include a name of the hotel, an address of the hotel, a type of suite reserved at the hotel, and a price associated with reserving the hotel. It should be understood that the experience 455 and the transactions 460 shown in FIG. 4B are illustrative only. In some arrangements, the results menu 455 can display different types of experiences, such as holidays, trips, dates, anniversaries, birthdays, celebrations, etc. Furthermore, the results menu 450 can display any number of transactions 460 associated with the experience 455.

The results menu 450 also includes actionable items 465a and 465b, each corresponding to a respective one of the transactions 460a and 460b. For example, the actionable item 465a allows the user to purchase tickets in order to re-create the air travel transaction 460a. The actionable item 465b allows the user to schedule a hotel reservation in order to re-create the accommodations transaction 460b. In some arrangements, the actionable items 465 are presented as selectable buttons. The user can select the buttons, for example, using a mouse, a stylus, a touch input, or another form of pointing device implemented by the input/output circuit 214 of the user computing device 110. Selecting one of the actionable items 460 can cause the user computing device 110 to transmit to the experience re-creation system 105 an indication that the user wishes to conduct the corresponding transaction.

Referring again to FIG. 3, the experience automation circuit 355 is configured to receive the indication that the user wishes to conduct a financial transaction resulting from the user selecting one of the actionable items 465 shown in FIG. 4B. The experience automation circuit 355 then performs the financial transaction automatically for the user. For example, in some arrangements, the experience automation circuit 355 contacts the merchant associated with the transaction that the user would like to re-create to schedule a future transaction with the merchant. In some arrangements, the experience automation circuit 355 may also receive additional information from the user, such as a time or date that the experience automation circuit 355 should select for the future transaction. Scheduling the future transaction allows the user to re-create aspects of the experience in an automated fashion.

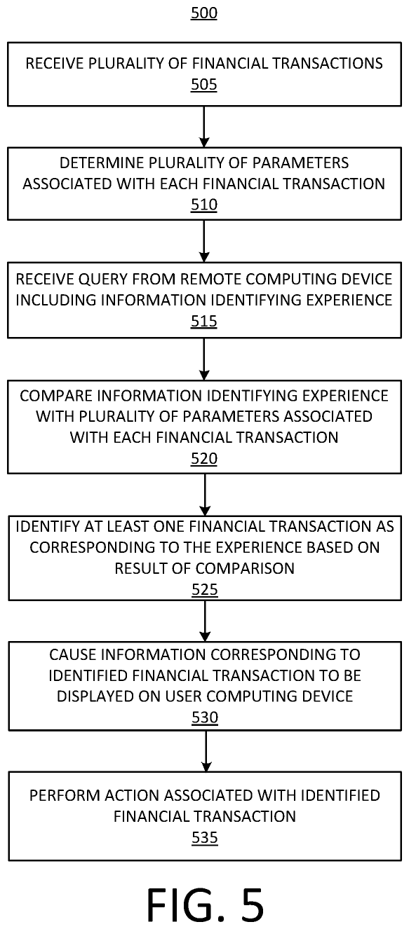

FIG. 5 is a flowchart illustrating an example method 500 for re-creating an experience of a user, according to an example embodiment. The method 500 is performed by the experience re-creation system 105. Accordingly, in arrangements where the experience re-creation system 105 is part of a financial institution, the method 500 may be performed by a financial institution computing system that includes the experience re-creation system 105. Generally, through the method 500, the experience re-creation system 105 processes a plurality of financial transactions, receives a query from a user relating to an experience the user wishes to recall or re-create, and identifies one or more transactions corresponding to the experience.

The method 500 begins when a plurality of financial transactions are received at 505. In some arrangements, this is performed by an account management circuit such as the account management circuit 330 shown in FIG. 3. In some arrangements, additional information is received along with the financial transactions. For each financial transaction, the information can include a time at which the transaction was completed, a location at which the transaction was completed, an identity of one or more counterparties to the transaction, a dollar amount associated with the transaction, and a product or service associated with the transaction. In some arrangements, the financial transactions are retrieved from a database. The account management circuit can receive any number of transactions, and the transactions may be associated with any number of users.

A plurality of parameters associated with each financial transaction of the plurality of financial transactions are determined at 510. In some arrangements, this step is performed by a parameter determination circuit such as the parameter determination circuit 335 shown in FIG. 3. Parameters for a transaction can include a time at which the transaction was conducted, a merchant associated with the transaction, a customer associated with the transaction, an event associated with the transaction, or an emotional response associated with the transaction. The determination of an event can be based in part on other parameters determined by the parameter determination circuit 335. For example, the parameter determination circuit can determine that a transaction occurred at a merchant corresponding to a music venue, and may therefore determine that an event associated with the transaction is a concert. In some arrangements, it can be determined that an event parameter of a transaction is a form of travel based on a determination that the transaction was conducted at location far from the home of the user who initiated the transaction. In some arrangements, the parameter determination circuit determines a rating parameter associated with a transaction. The rating parameter indicates a level of satisfaction or dissatisfaction experienced by the user who conducted the transaction. In some arrangements, the plurality of parameters can be stored in a searchable database or other memory storage device, such as the database 260 shown in FIG. 2.

A query is received from a remote computing device at step 515. This step can be performed by an experience identification circuit such as the experience identification circuit 345 shown in FIG. 3. The query includes an indication of an experience that a user of the remote computing device wishes to recall or re-create. In some arrangements, the remote computing device can be one of the user computing devices 110 shown in FIG. 2. As described above, the user can be presented with a prompt to enter search terms corresponding to the query, for example via a graphical user interface such as the query menu 405 shown in FIG. 4. The user enters search terms and submits the search terms, which are received by the experience identification circuit. In some implementations, the search terms include or relate to contextual information associated with the experience that the user wishes to recall or re-create. For example, the search terms may include a type of experience, a date or location at which the experience took place, an identification of another user who participated in the experience, or any other form of information that identifies the experience.

The information identifying the experience is compared with the plurality of parameters associated with each financial transaction of the plurality of financial transactions at 520. This step can be performed by the experience identification circuit. In some arrangements, the experience identification circuit is configured to parse or otherwise process the information identifying the experience to extract one or more search terms (e.g., words or phrases) provided by the user as part of the query received at 515. The extracted search terms are then compared with the plurality of parameters for each financial transaction to determine a degree of similarity (or in some arrangements, an exact match) between the extracted search terms and the plurality of parameters. Based on a result of the comparison (i.e., the determined match or similarity), the experience identification circuit determines that the at least one financial transaction corresponds to the experience that the user wishes to recall or recreate at 525. It should be understood that, in some arrangements, the experience identification circuit can identify an experience without receiving a query at step 520. For example, as described above, the experience identification circuit can identify a suggested or recommended experience that the user may wish to re-create based on factors such as a location of a user computing device or on recurring events, such as birthdays, holidays, or anniversaries.

In some arrangements, the method 500 includes causing information corresponding to the one or more identified financial transactions to be displayed on a user computing device at 530. This step can be performed by a GUI circuit such as the GUI circuit 350 shown in FIG. 3. In some arrangements, the GUI circuit receives the one or more financial transactions identified as corresponding to the experience from the experience identification circuit. The GUI circuit then generates information corresponding to an interface for providing information related to the identified transactions. In some arrangements, such an interface can be formatted in a manner similar to that of the results menu 450 shown in FIG. 4B. For example, the interface can include an indication of the experience, as well as a list of financial transactions associated with the experience. Any number of financial transactions can be shown. In some arrangements, the interface also includes an actionable item associated with at least one of the financial transactions. The actionable item can be selectable by a user, and can correspond to an action that allows the financial transaction to be schedule in the future. For example, for a financial transaction corresponding to a purchase of a meal at a restaurant, the actionable item can include making a reservation at the same restaurant for a time in the future. In some arrangements, the user can select a button or other interface element associated with the actionable item, causing an experience automation circuit such as the experience automation circuit 355 shown in FIG. 3 to perform the associated action. Thus, the user can re-create at least a portion of the experience by repeating the transaction at a time in the future.

In some arrangements, the method 500 further includes automatically performing an action associated with the identified financial transaction at step 535. This can be performed, for example, by the experience automation circuit such as the experience automation circuit 355 shown in FIG. 3. In some arrangements, an indication that the user wishes to conduct a financial transaction is received as a result of the user selecting one of the actionable items described above. The experience automation circuit can perform the action automatically for the user. For example, in some arrangements, the experience automation circuit contacts the merchant associated with the transaction that the user would like to re-create to schedule a future transaction with the merchant. In some arrangements, additional information also is received from the user, such as a time or date that should be selected for the future transaction. The future transaction can be schedule in an automatic fashion such that user is able to re-create a portion of the identified experience through the future transaction.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more dedicated processors may execute instructions stored in the dedicated memory or may execute instructions otherwise accessible to the one or more dedicated processors. In some embodiments, the one or more dedicated processors may be embodied in various ways. The one or more dedicated processors may be constructed in a manner sufficient to perform at least the operations described herein. In some embodiments, the one or more dedicated processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more dedicated processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more dedicated processors may take the form of a single core processor, multi-core processor (e.g., a dual core processor, triple core processor, quad core processor, etc.), microprocessor, etc.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method comprising:
receiving, by one or more processors, a plurality of financial transactions;
receiving, by the one or more processors, from an audio input, voice information corresponding to each of the plurality of financial transactions;
determining, by the one or more processors, based on the voice information corresponding to each financial transaction, a parameter audible volume of the voice information corresponding to each of the plurality of financial transactions;
determining, by the one or more processors, an emotional state parameter for each transaction based on the parameter audible volume corresponding to each of the plurality of financial transactions;
receiving, by the one or more processors, a query from a remote computing device to re-create an experience of a user;
identifying, by the one or more processors, from the query, an emotional state parameter during the experience;
comparing, by the one or more processors, the emotional state parameter during the experience with each emotional state parameter associated with each of the plurality of financial transactions;
identifying, by the one or more processors, at least one financial transaction of the plurality of financial transactions as corresponding to the experience based on comparing of the emotional state parameter during the experience with each emotional state parameter associated with each of the plurality of financial transactions;
generating, by the one or more processors, information corresponding to the financial transaction identified as corresponding to the experience;
causing, by the one or more processors, the information corresponding to the at least one financial transaction corresponding to the experience to be displayed on a display screen of the remote computing device;
generating, by the one or more processors, information corresponding to at least one actionable item associated with the at least one financial transaction identified as corresponding to the experience; and
causing, by the one or more processors, the information corresponding to the at least one actionable item to be displayed on the display screen of the remote computing device.

2. The computer-implemented method of claim 1, further comprising receiving, by the one or more processors, a plurality of parameters, wherein the plurality of parameters associated with each of the plurality of financial transactions comprise at least one of a time of the respective financial transaction, a location associated with the respective financial transaction, a merchant associated with the respective financial transaction, an individual who initiated the respective financial transaction an event associated with the respective financial transaction, and a rating associated with the respective financial transaction.

3. The computer-implemented method of claim 2, further comprising:
receiving, by the one or more processors, for each of the plurality of financial transactions, information associated with the parameter audible volume of the individual who initiated the financial transaction; and
determining, by the one or more processors, the parameter audible volume of the individual who initiated the financial transaction.

4. The computer-implemented method of claim 3, wherein receiving the information associated with the parameter audible volume of the individual who initiated the at least one financial transaction further comprises receiving, by the one or more processors, information corresponding to a conversation or phone call involving the individual who initiated the at least one financial transaction.

5. The computer-implemented method of claim 1, wherein the information identifying the experience included in the query includes information identifying an individual associated with the experience.

6-8. (canceled)

9. The computer-implemented method of claim 1, further comprising:
receiving, by the one or more processors, a request for an action associated with the at least one actionable item to be performed; and
performing, by the one or more processors, the action associated with the at least one actionable item.

10. The computer-implemented method of claim 9, wherein the action associated with the at least one actionable item includes at least one of making a restaurant reservation, purchasing a ticket for an event, and making a hotel reservation.

11. A system comprising:
one or more processors and a memory having stored thereon instructions which, when executed by the one or more processors, cause the one or more processors to:
receive, from an audio input, voice information corresponding to each of a plurality of financial transactions;
determine, based on the voice information corresponding to each financial transaction, a parameter audible volume of the voice information corresponding to each of the plurality of financial transactions;
determine an emotional state parameter for each of the plurality of financial transactions based on the parameter audible volume corresponding to each of the plurality of financial transactions;
receive a query from a remote computing device to re-create an experience of a user, the query including information identifying the experience;
extract, from the information identifying the experience, an emotional state parameter during the experience;
compare the emotional state parameter during the experience with each emotional state parameter associated with each of the plurality of financial transactions;
identifying at least one financial transaction of the plurality of financial transactions as corresponding to the experience based on comparing of the emotional state parameter during the experience with each emotional state parameter associated with each of the plurality of financial transactions;
generate information corresponding to the at least one financial transaction corresponding to the experience;
cause the information corresponding to the at least one financial transaction corresponding to the experience to be displayed on a display screen of the remote computing device;
generate information corresponding to at least one actionable item associated with the at least one financial transaction corresponding to the experience; and
cause the information corresponding to the at least one actionable item to be displayed on the display screen of the remote computing device.

12. The system of claim 11, wherein the instructions further cause the one or more processors to receive a plurality of parameters, wherein the plurality of parameters associated with each of the plurality of financial transactions comprise at least one of a time of the respective financial transaction, a location associated with the respective financial transaction, a merchant associated with the respective financial transaction, an individual who initiated the respective financial transaction, an event associated with the respective financial transaction, and a rating associated with the respective financial transaction.

13. The system of claim 12, wherein the instructions further cause the one or more processors to:
receive, for each of the financial transactions of the plurality of financial transactions, information associated with the parameter audible volume of the individual who initiated the financial transaction; and
determine the parameter audible volume of the individual who initiated the financial transaction.

14. The system of claim 13, wherein the wherein the instructions further cause the one or more processors to receive the information associated with the parameter audible volume of the individual who initiated the at least one financial transaction by receiving information corresponding to a conversation or phone call involving the individual who initiated the at least one financial transaction.

15. The system of claim 11, wherein the information identifying the experience included in the query includes information identifying an individual associated with the experience.

16-18. (canceled)

19. The system of claim 11, further comprising an experience automation circuit configured to:
receive a request for an action associated with the at least one actionable item to be performed; and
perform the action associated with the at least one actionable item.

20. The system of claim 19, wherein the action associated with the at least one actionable item includes at least one of making a restaurant reservation, purchasing a ticket for an event, and making a hotel reservation.

21. The method of claim 1, further comprising:
identifying, by the one or more processors, from the query, an experience audible volume during the experience;
comparing, by the one or more processors, the experience audible volume during the experience with each experience audible volume associated with each of the plurality of financial transactions; and
identifying, by the one or more processors, the at least one financial transaction of the plurality of financial transactions as corresponding to the experience based on comparing of the experience audible volume during the experience with each experience audible volume associated with each of the plurality of financial transactions.

22. The system of claim 11, wherein the one or more processors are further configured to:
identify from the query, an experience audible volume during the experience;
compare the experience audible volume during the experience with each experience audible volume associated with each of the plurality of financial transactions; and
identify the at least one financial transaction of the plurality of financial transactions as corresponding to the experience based on comparing of the experience audible volume during the experience with each experience audible volume associated with each of the plurality of financial transactions.
